(19) United States
(12) Patent Application Publication
(10) Pub. No.: US 2003/0224155 A1
(43) Pub. Date: Dec. 4, 2003

(54) Electronically controllable, visually dynamic textile, fabric, or flexible substrate

(75) Inventors: Margaret A. Orth, Cambridge, MA (US); Joanna M. Berzowska, Montreal (CA)

Correspondence Address: TESTA, HURWITZ & THIBEAULT, LLP, HIGH STREET TOWER, 125 HIGH STREET, BOSTON, MA, 02110, US

(73) Assignee: International Fashion Machines, Inc., Cambridge, MA

(21) Appl. No.: 10/445,683

(22) Filed: May 27, 2003

Related U.S. Application Data
(60) Provisional application No. 60/385,203, filed on Jun. 3, 2002.

(51) Int. Cl. B32B 7/08; D03D 15/00

(52) U.S. Cl. 428/223; 428/913; 442/189; 156/47; 156/49

(57) ABSTRACT

A textile with dynamic, visual displays and a method for manufacturing such a textile are described. The textile is manufactured by weaving, embroidering, or otherwise integrating a series of conductive, resistive, and non-conductive fibers into the textile and printing a thermoresponsive colorant on or near the resistive fiber. The pattern and physical configuration of the materials composing the textile determine the visual properties of the textile. Electrical power is supplied to the resistive fiber(s) to change the visual properties of the textile. As the resistive fiber warms, the thermoresponsive colorant is warmed beyond a thermal threshold necessary to effect a color change in the thermoresponsive colorant, thereby creating an electronically controllable, visually dynamic textile.

### CROSS-REFERENCE TO RELATED APPLICATIONS

This application claims the benefits of and priority to U.S. Provisional Patent Application Serial No. 60/385,203 filed on Jun. 3, 2002, commonly owned herewith, the disclosures of which are hereby incorporated herein by reference in their entirety.

### FILED OF THE INVENTION

The invention relates generally to the fields of textile manufacturing and visual displays and more specifically to the integration of visual displays into textiles.

### BACKGROUND OF THE INVENTION

Ongoing efforts to integrate computing devices with common articles of clothing—frequently termed “wearable computing” applications—typically have not involved changes to the clothing items themselves. Rather, for the most part, electronic devices have been mechanically attached to or fitted within clothing, or have been adapted to be directly worn by the user. More recently, textiles themselves have been modified to participate functionally in the design and operation of electronic devices (rather than serving merely as scaffolds). For example, U.S. Pat. No. 6,210,771 describes textiles having conductive fibers incorporated within the weave, facilitating direct application of electronic components to the textile itself. Still, the patterns, designs, and visual appearance of clothing involving wearable-computing capabilities have generally been fixed. For example, applications involving readouts typically utilize a conventional medium, like a LCD or LED display attached to the textile, rather than modifying the appearance of the textile itself.

This approach is limiting, since it separates the interactive component from the textile; the application is “wearable” in the sense that it is borne by the user, but it is less a part of his or her clothing than an appendage thereto. Outside the context of textiles worn as clothing, conventional approaches uniting electronic circuitry with textiles do not alter visual characteristics of the textile itself, but rather merely add separate electronic functionality. A need therefore exists for textiles that are themselves capable of changing in appearance in coordination with computational components.

### SUMMARY OF THE INVENTION

The invention provides dynamic, visual displays within and on a textile and techniques for manufacturing such a textile. This is accomplished by printing onto the textile thermoresponsive colorants, such as inks or dyes, which are selectively activated by heating a resistive fiber woven, embroidered, or otherwise integrated into the textile. In addition, the thermoresponsive colorant may be incorporated into conductive or resistive fibers used to fabricate the textile. The pattern and physical configuration of the colorants, resistive fibers, and conductive fibers then determine the visual properties of the textile, thereby creating an electronically controllable, visually dynamic textile with addressable display dynamics. Suitable textiles are not limited solely to wearable computing applications, but also will find utility in dynamic signs, paintings, or interior wall-coverings.

In one aspect, the textile includes a plurality of spaced-apart contacts for receiving electrical power. Additionally, at least one resistive fiber is connected to each of the contacts and is running along a first direction, while a thermoresponsive colorant is printed along at least a portion of the at least one resistive fiber. The thermoresponsive colorant changes color in response to heat generated by a voltage disposed across the contacts, which causes the at least one resistive fiber to produce heat and thereby change the color of the colorant.

The thermoresponsive colorant may be responsive within a temperature range of about 31° C. to about 45° C.; a preferred temperature range is about 31° C. to about 34° C. In one embodiment, the thermoresponsive colorant is in the form of ink applied to the textile in the region of the resistive fiber, whereas in another embodiment, the thermoresponsive colorant is in the form of a dye. In yet another embodiment, at least a portion of the thermoresponsive colorant is within the resistive fiber itself. The resistive fiber may have a resistance between about 15 to about 100 Ω.

In one embodiment, each contact includes a series of conductive fibers running along a second direction distinct from the first direction. Alternatively, each contact may be (or include) a discrete electrical connector, e.g., a metal grommet or staple. In one embodiment, the textile is woven, and the conductive fibers run along a weft direction, while the resistive fibers run along a warp direction. In various embodiments, the at least one resistive fiber is either woven, sewn, embroidered, or otherwise adhered to the textile. In addition, the thermoresponsive colorant may be within the conductive fibers.

In another aspect, the invention relates to a method for manufacturing a textile. The method includes providing a plurality of spaced-apart contacts for receiving electrical power and electrically coupling the contacts to at least one resistive fiber running along a first direction. In addition, a thermoresponsive colorant, which is printed along at least a portion of the at least one resistive fiber, changes color in response to heat generated by applying a voltage across the at least one resistive fiber.

In one embodiment, the contacts and the at least one resistive fiber are coupled so as to minimize the resistance between them. The resistance may be less than about 10 Ω. Each contact may include a series of conductive fibers running along a second direction distinct from the first direction, and in one embodiment, at least two of the plurality of spaced-apart contacts may be separated by cutting the series of conductive fibers. Alternatively or in addition, at least two of the plurality of contacts may be insulated by weaving a non-conductive fabric between them. In one embodiment, the method includes attaching at least one lead having at least one conductive fiber to at least one of the series of conductive fibers.

In another aspect, the invention provides a system including a textile with addressable color characteristics. This system includes a first set of spaced-apart resistive fibers extending along a first direction; interwoven therewith are a second set of spaced-apart resistive fibers extending along a second direction. A thermoresponsive colorant is printed at least at points of intersection between fibers of the first set and fibers of the second set. A power source is connectable to selected ones of the first set of fibers and the second set of fibers, and a voltage applied across intersecting fibers causes the thermoresponsive colorant to change color only in a region where the intersecting fibers cross.

The thermoresponsive colorant undergoes color change as a function of time and of a voltage applied through a resistive fiber in contact with the colorant. The color change exhibits hysteresis, and the system also includes a controller for operating the power source to vary, over time, the fibers to which power is applied in order to activate only selected points of intersection without interference by neighboring points of intersection.

Other aspects and advantages of the invention will become apparent from the following drawings, detailed description, and claims, all of which illustrate the principles of the invention, by way of example only.

### BRIEF DESCRIPTION OF THE DRAWINGS

The foregoing and other objects, features, and advantages of the invention described above will be more fully understood from the following description of various embodiments, when read together with the accompanying drawings. In the drawings, like reference characters generally refer to the same parts throughout the different views. The drawings are not necessarily to scale, and emphasis instead is generally placed upon illustrating the principles of the invention.

FIG. 1 is a schematic diagram of an electrical circuit, which is representative of a circuit made with fibers of a textile in accordance with the invention;

FIG. 2 is a plan view of a textile with color-changing striped regions;

FIG. 3 is a plan view of a textile embroidered with a resistive fiber to create a non-rectangular color-response region;

FIG. 4 is a plan view of a contact formed from a conductive fiber and a resistive fiber;

FIG. 5 depicts a plan view of a textile that illustrates ways of electrically isolating contacts and minimizing contact resistance; and

FIG. 6 is a plan view of a fully addressable matrix display constructed in accordance with the invention.

### DETAILED DESCRIPTION OF THE PREFERRED EMBODIMENTS

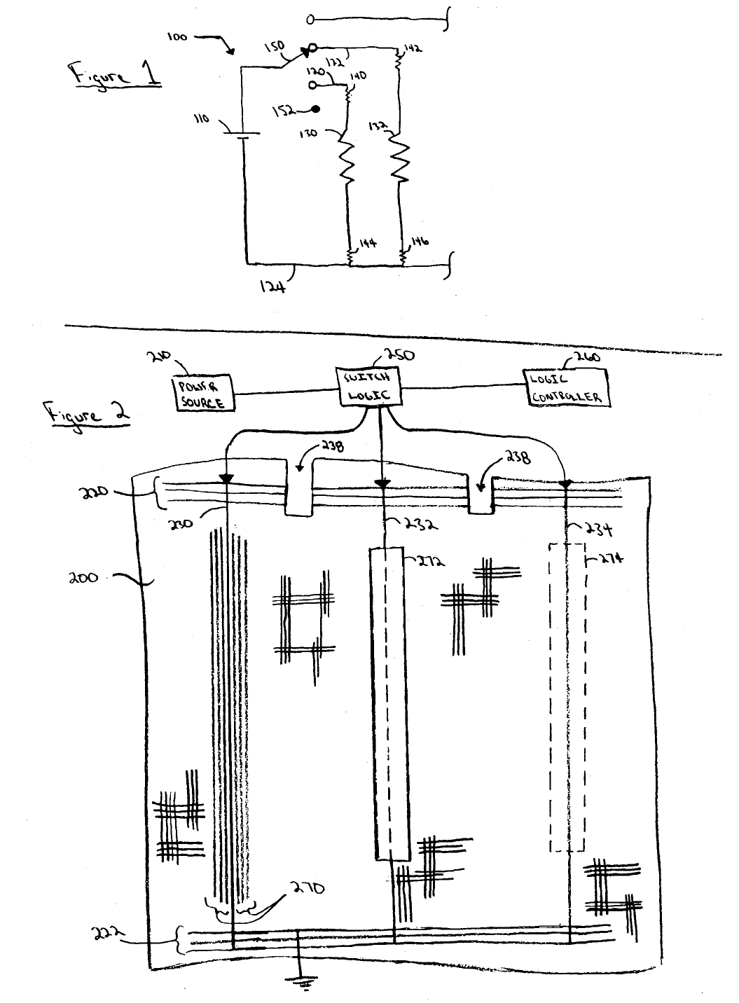

FIG. 1 illustrates a schematic diagram of an electrical circuit 100, which is representative of a circuit made with fibers of a textile in accordance with the invention. As used herein, the term “fiber” refers to any filament, group of filaments twisted together, yarn, thread, rope, cord, strand, or wire amenable to weaving, embroidering, stitching, felting, sewing, knitting, or otherwise incorporating into a textile as part of a textile manufacturing process or enhancing a textile manufactured by such a process. As used herein, the term “textile” refers to any pliable material including, but not limited to, a cloth, fabric, tapestry, or canvas made by weaving, embroidering, stitching, felting, sewing, knitting, or otherwise incorporating fibers into a pliable material. A battery or power source 110 supplies electricity. A series of conductive fibers 120, 122, 124 run in one direction, while a pair of resistive fibers 130, 132 run along a second (e.g., perpendicular) direction. The resistors 140, 142, 144, 146 represent contact resistances developed where the conductive fibers 120, 122, 124 join the resistive fibers 130, 132. The resistive fibers 130, 132 are selected so that the resistance is larger in the fibers than at the contacts. The power source 110 may be connected to the conductive fibers 120, 122, 124 by conventional electrical wiring. Control electronics, including a switch 150 intervening between the power source 110 and the conductive fibers 120, 122, can activate specific resistive fibers, and therefore specific areas of the textile to create animation. Alternatively, the switch 150, which includes an off position 152, can be configured to activate and deactivate all of the conductive fibers. An off position 152 for the switch 150 is illustrated in FIG. 1.

The contacts need not be a series of conductive fibers. For example, a contact may be a discrete electrical connector, such as a metal grommet, metal staple, or other suitable connector. The discrete electrical connector may contact the resistive fiber independently or secure a running fiber contact, such as a series of conductive fibers, to a resistive fiber, as described in more detail below.

The resistances of the resistive fibers 130, 132 are generally greater than about 10 Ω, and preferably greater than about 20 Ω. The resistances of the resistive fibers 130, 132 may be as large as about 1000 Ω or more. The resistance at the contact points 140, 142, 144, 146 is generally less than about 10 Ω, and preferably less than about 5 Ω. The resistances of the conductive fibers 120, 122, 124 (e.g., less than about 1 Ω per foot) are considerably less than the resistance of the contact points 140, 142, 144, 146. Techniques for reducing contact resistance are discussed below.

The source of electrical power will depend on the textile and its intended use. For example, a bench power supply or wall outlet may be preferable for a cubicle wall or interior design, whereas a battery or solar cell may work best for an article of clothing. The rapidity with which a color change is effected depends on how fast the resistive fiber heats up and, in turn, heats a thermoresponsive material. How fast the fiber heats up is determined by the voltage supplied and the resistance of the fiber 130, 132. To the extent that a slow response time can be tolerated, lower voltages can be utilized.

In a preferred embodiment, the source of electrical power uses pulse-width modulation (PWM) to heat resistive fibers at adjustable energizing levels with precise timing control. PWM permits the same power source to be used to drive textiles with resistive fibers that have different resistances by delivering different amounts of energy to individual resistive fibers or regions of the textile. The magnitude of the voltage, the resistance of the fiber, and the duration of the pulse may all determine the energy delivered to a particular resistive fiber. In addition, the current level and/or pulse width applied to a particular resistive fiber may be reduced after a color change is initially achieved in order to maintain the color change. In this way, the total energy delivered to a resistive fiber overtime can be minimized while maintaining the color change.

A wide variety of conductive and resistive fibers may be used to advantage. Suitable conductive fibers include, for example, the ARACON brand metal clad fibers available from DuPont and various stainless steel fibers available from Bekaert. These fibers may include a polymer core wrapped with a layer of either conductive or resistive metal, and then coated with a polymer for protection. In addition, the fiber may be metal fibers plated with the KEVLAR brand material available from DuPont, a metal foil or strand wrapped with polyester, or other composite material constructed from polyester and metal fibers.

A thermoresponsive, or thermochromic, material is a material that changes color as the temperature of the material increases over a predetermined thermal threshold. In various embodiments, the thermoresponsive material is in the form of an ink (e.g., DYNACOLOR screen inks available from Chromatic Technologies, Inc.), a dye (e.g., a leuco-dye product available from Color Changing, Corp.), or may be the resistive fiber itself (e.g., having a thermochromic ink or dye embedded into the structure); fabrication of suitable thermochromic fibers is described, for example, in U.S. Pat. No. 6,444,313, the entire disclosure of which is hereby incorporated by reference. When thermoresponsive inks and dyes are printed on the textile to represent a pattern or design of interest, the heat generated by the resistive fibers effects a color change in the ink or dye. For example, if the ink or dye is deposited (e.g., by a printing process such as screen printing, deposition (such as ink-jet) printing) in the region over and surrounding the resistive fiber, the areas closest to the fiber will undergo transition first, and the transition will then spread to more remote regions (to the extent that the surrounding material can conduct heat). As explained below, for this reason it is desirable to have the resistive fibers conform, to the extent practicable, to the thermochromic region. For example, in a region of the textile treated with a thermoresponsive ink or dye, four resistive fibers running in a first direction of a textile may be spaced about 0.25 inches apart. Within seconds of applying electrical power to the resistive fibers, the thermoresponsive ink or dye will change color, thereby creating a strip approximately one inch wide and running the length of the first direction.

If the thermoresponsive colorant is contained within the resistive fiber itself, mixing of colors is possible by printing a thermally unresponsive ink or dye on the textile. For example, a textile can be treated with yellow ink that is not thermoresponsive. A thermoresponsive, resistive fiber, which is blue in color but which becomes transparent when heated to its critical temperature, can be incorporated within the yellow textile. Yellow and blue are primary colors that subtractively mix to give the textile an appearance of green. When electricity is applied, the resistive fiber will heat up and change from blue to transparent. Thus, only the yellow, thermally unresponsive dye will be visible. Thus, the observed color depends on the current state of the thermoresponsive, resistive fiber and the thermally unresponsive ink printed on the textile.

Thermally responsive and unresponsive inks and dyes can be applied using conventional printing process, as noted above. In general, thermochromic materials have a critical temperature at which they undergo color transition and are hysteretic; that is, the color change persists until the material cools to a temperature below the critical temperature. In order to facilitate unassisted return to the initial color state in everyday environments, the critical temperature should be above room temperature. On the other hand, to avoid excessive response times, the critical temperature should be close enough to room temperature that a relatively small temperature shift is sufficient to bring about a color change. A preferred critical temperature range is about 31° C. to about 45° C.; a particularly preferred temperature range is from about 31° C. to about 34° C.

Thermochromic materials can change from one color to a second color, or from one color to transparent. Indeed, fibers can be fabricated to exhibit this behavior even if the thermochromic material itself only undergoes transition between colored and transparent. For example, a fiber can be treated with thermally unresponsive yellow ink and with blue thermoresponsive ink. The yellow and blue will mix to form green. When the fiber is heated, the blue will turn to transparent, and the yellow will be the dominant color. In this manner, shades of yellow and green are formed.

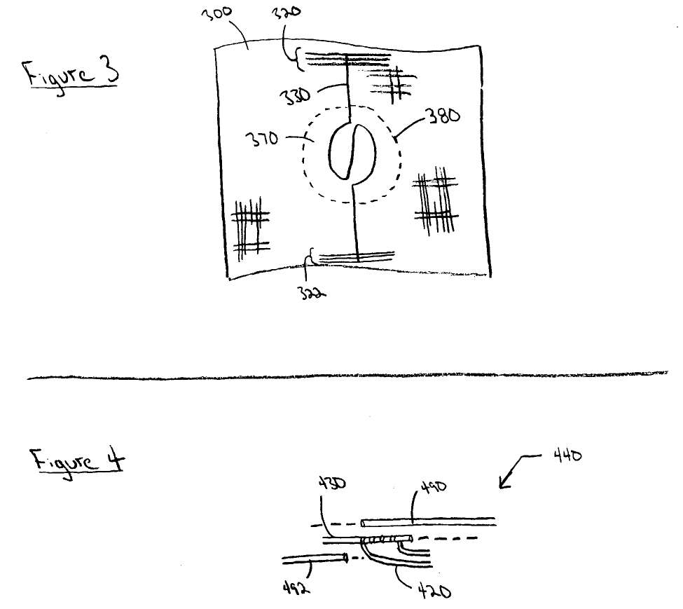

FIG. 2 illustrates an implementation suitable for creating color-changing stripes on a textile 200. Resistive, conductive, and non-conductive fibers and yarns are woven together to form the textile. In FIG. 2, a plurality of conductive fibers 220 form a first contact woven along a first direction, and another set of conductive fibers 222 form a second, parallel contact spaced from fibers 220. One or more resistive fibers representatively indicated at 230, 232, 234 are woven along a second direction (e.g., perpendicular to the first direction, as illustrated). In one embodiment, the conductive fibers 220, 222 extend along the weft, and the resistive fibers 230, 232, 234 are woven along the warp. Contacts are formed where the conductive fibers 220, 222 join the resistive fibers 230, 232, 234. Adjacent contacts may be electrically isolated by cutting a notch 238 between them. A power source 240 supplies electrical power to a switch matrix 250 and a logic controller 260, which direct the electricity to the resistive fiber or fibers of interest. In some instances, electricity will be supplied simultaneously to a plurality of resistive fibers along distinct electrical paths.

A thermoresponsive colorant 270, 272, 274 can be applied to the textile 200 in a variety of manners. With respect to resistive fiber 230, the thermoresponsive colorant is in the form of non-conductive fibers 270 that have been treated with an ink or dye prior to being woven parallel or adjacent to the resistive fiber 230. When electrical power is supplied to the resistive fiber 230, the surrounding non-conductive fibers 270 warm up and change color.

With respect to resistive fiber 232, an area 272 of the textile 200 is printed with a thermoresponsive ink or dye after weaving the textile 200 (including the fiber 232). As the resistive fiber 232 warms, the thermoresponsive colorant in the area 272 proximate to resistive fiber 232 will change color. Again, the farther the region 272 extends to each side of the fiber 232, the longer it will take for the response to propagate to the edge. This delay can be exploited, if desired, as an animation effect.

With respect to resistive fiber 234, an area 274 of the textile 200 is first printed with a thermoresponsive ink or dye. Then, the resistive fiber 234 is sewn or embroidered into the area 274 containing the thermoresponsive colorant. When electrical power is supplied and the resistive fiber 234 warms, the area 274 of the textile 200 printed with the thermoresponsive colorant will change color.

The thermoresponsive fiber can, if desired, incorporate a plurality of resistive fibers woven in close proximity. Therefore, a larger area will change color, or the color change may occur at a faster rate because a large area is heated. In another embodiment, a plurality of resistive fibers are woven along both the warp and the weft, thus forming contacts. When electrical power is supplied, intersecting lines are formed in an area printed with a thermoresponsive colorant.

Alternatively, a textile may be woven with both untreated fibers, which are subsequently treated with a thermoresponsive colorant. The textile is then treated with a resistive ink, and a power source is connected across the resistive region. When electrical power is supplied, the resistive region heats up, causing thermoresponsive color transition. The placement and pattern of the thermoresponsive fibers will determine the design of the dynamic visual pattern.

FIG. 3 illustrates an embodiment showing how embroidery can be used in a textile 300 to create a non-rectangular color-response region. A resistive fiber 330 is embroidered in a shape 370 of interest, in this case a circle. A thermoresponsive colorant 380 is applied around the embroidered shape 370; the embroidery effectively acts as a “skeleton” within, and conforms as much as possible to, the printed region 380. When electrical power is supplied, the circle 380 will appear on the textile 300 where the thermoresponsive colorant changes color.

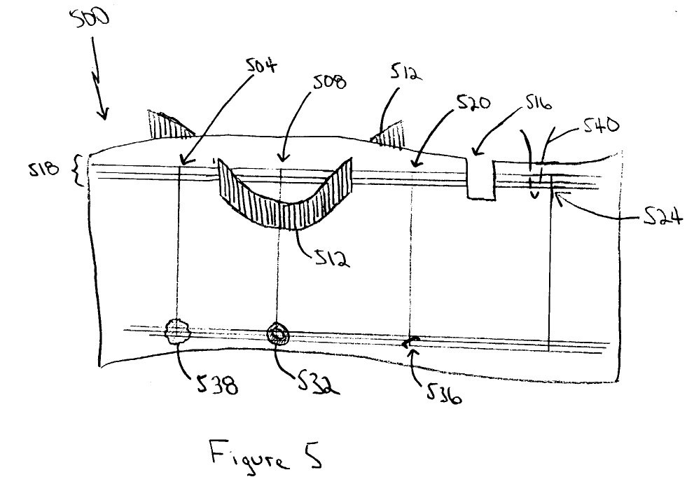

FIG. 4 illustrates one approach to forming a contact, and minimizing resistance, when joining conductive and resistive fibers during the embroidery process. As illustrated, a contact 440 formed from a conductive fiber 420 and a resistive fiber 430 woven among a series of non-conductive fibers 490 and 492, which compose the bulk of the textile. By placing the resistive fiber 430 in the bobbin and the conductive fiber 420 in the needle of the sewing machine, the conductive fiber 420 can be wound around the resistive fiber 430 as shown, thereby ensuring good mechanical contact extending over a length of the resistive fiber 430.

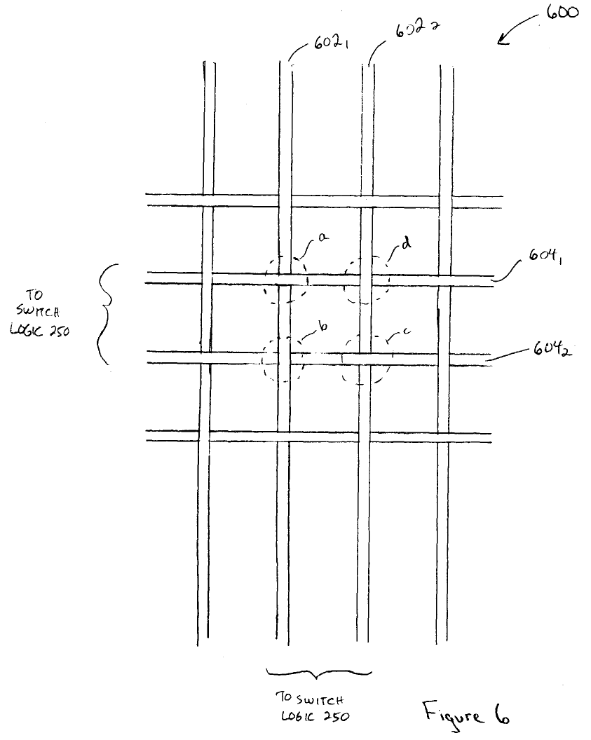

FIG. 5 depicts approaches to separating contacts and minimizing contact resistance in a textile 500. For example, adjacent contacts 504, 508 may be separated by weaving an electrically insulating fiber or textile 512 between the contacts 504, 508. As described above, a notch 516 may be cut in the region of the conductive fibers 518 to electrically isolate the contacts 520, 524. FIG. 5 also illustrates various ways of connecting fibers to contacts. As illustrated, satisfactory mechanical and electrical connections may be achieved by means of a metal grommet 532 or a metal staple 536. A conductive ink, paint, adhesive, or polymer 538 may instead or also be used to minimize contact resistance. According to the illustrated embodiment, a conductive fiber lead 540 is woven in the region of the conductive fibers 518 to connect the contact to a power source or an external load.

The invention is amenable to numerous applications. For example, a textile, printed with stripes of thermoresponsive colorant may be attached to a sneaker in order to form a pedometer. The individual stripes are selectively controlled, and the number of stripes activated represents a numerical quantity, e.g., steps taken, distance covered, calories burned, etc. For example, a counting circuit may include a piezoelectric device embedded in the sole of the sneaker that not only supplies the overall electrical power, as described in U.S. Pat. No. 5,930,026 (the entire disclosure of which is hereby incorporated by reference), but also serves as input to the step counter through flexion each time the user takes a step. As the distance covered by the user (as measured by sole flexions) increases, the counting circuit activates more stripes, thereby providing a visual read-out.

The present invention is amenable to a wide variety of applications involving virtually any type or use of textiles. These can include, for example, signage, decorative wall coverings, and paintings. Dynamic signage may, for example, be created by printing text in a thermoresponsive colorant. For example, a textile may be embroidered with resistive fibers, and printed with the letters “E-A-T” using thermoresponsive ink on a background of similarly colored non-responsive ink. When the resistive fibers are heated, the letters change color, and with suitable contrast, reveal the message. The letters may be activated simultaneously or in sequence to produce a dynamic image.

The hysteretic properties of thermoresponsive colorants can be used to facilitate fabrication of a fully addressable matrix display. A 2×2 matrix is illustrated in FIG. 6 to explain the principle, it being understood that this principle is fully scalable to any desired matrix dimensionality. A textile, indicated generally at 600, has a pair of vertical resistive fibers 602₁, 602₂, and a pair of horizontal resistive fibers 604₁, 604₂. These fibers, it should be emphasized, need not be directly adjacent as suggested in the figure; instead, they may be separated by one or more non-conductive fibers. Circular regions a, b, c, d of thermoresponsive colorant are applied at the intersections of the resistive fibers 602₁, 602₂, 604₁, 604₂. The circular regions a, b, c, d act as pixels of the matrix display.

In order to facilitate activation of a single pixel, logic controller 260 (see FIG. 2) causes the two fibers crossing the desired pixel to receive a voltage (via switch logic 250) having a selected magnitude, and for a chosen time period, such that thermochromic activation will occur only where the two fibers intersect. This is straightforwardly accomplished because the heat developed by a fiber is a predictable function of voltage magnitude and time. For example, if pixel c is to be activated, switch logic 250 energizes fibers 602₂, 604₂ such that pixels b and d remain unaffected (because the heat developed at these regions is insufficient).

Without more, however, this scheme would not permit activation of arbitrary desired pixels due to the possibility of crosstalk. For example, suppose it is desired to activate pixels a and c. This requires energizing all four resistive fibers 602₁, 602₂, 604₁, 604₂, resulting in unwanted activation of all four pixels a, b, c, d. To avoid this, the hysteretic nature of the thermoresponsive colorant is exploited. The controller 260 causes switch logic 250 to cycle between energizing fibers 602₁, 60₄, (thereby activating pixel a) and fibers 602₂, 604₂ (thereby activating pixel c). The time between cycles is sufficiently short to avoid deactivation of thermochromic material corresponding to pixels a and c, due to hysteresis, while also preventing spurious activation of pixels at other points of intersection (e.g., pixels b and d). Reliance on hysteresis is minimal for a 2×2 matrix, as illustrated, but grows with the size of the matrix; the larger the matrix, the greater will be the number of other fiber pairs that must be energized between consecutive cycles energizing a particular fiber pair. On the other hand, multiple pixels involving non-interfering fibers can be simultaneously activated, reducing the time between successive activations of a given pixel.

It should also be noted that the thermoresponsive colorant need not be applied in the form of discrete circles. Timing, once again, and also the voltage level can be used to cause activation of colorant only in the immediate region of an intersection, allowing the colorant to be applied indiscriminately over the entire matrix. (Thus, the pixels shown in FIG. 6 would represent regions of influence rather than discrete patches of colorant.)

Although the invention has been described with reference to specific details, it is not intended that such details should be regarded as limitations upon the scope of the invention, except as and to the extent that they are included in the accompanying claims.

What is claimed is:

1. A textile comprising:
a. a plurality of spaced-apart contacts for receiving electrical power;
b. at least one resistive fiber connected to each of the contacts and running along a first direction; and
c. a thermoresponsive colorant along at least a portion of the at least one resistive fiber, the colorant changing color in response to heat, a voltage across the contacts causing the at least one resistive fiber to produce the heat and thereby change the color of the colorant.

2. The textile of claim 1, wherein the thermoresponsive colorant is responsive within a temperature range of about 31° C. to about 45° C.

3. The textile of claim 1, wherein the thermoresponsive colorant is responsive within a temperature range of about 31° C. to about 34° C.

4. The textile of claim 1, wherein the thermoresponsive colorant is in the form of an ink applied to the textile in the region of the at least one resistive fiber.

5. The textile of claim 1, wherein the thermoresponsive colorant is in the form of a dye applied to the textile in the region of the at least one resistive fiber.

6. The textile of claim 1, wherein at least a portion of the thermoresponsive colorant is within the at least one resistive fiber.

7. The textile of claim 1, wherein the textile is embroidered with the at least one resistive fiber in a shape of interest.

8. The textile of claim 1, wherein the at least one resistive fiber has a resistance between about 15 to about 100 Ω.

9. The textile of claim 1, wherein each contact comprises a series of conductive fibers running along a second direction distinct from the first direction.

10. The textile of claim 9, wherein the series of conductive fibers runs along a weft direction and the at least one resistive fiber runs along a warp direction.

11. The textile of claim 9, wherein at least a portion of the thermoresponsive colorant is within at least one of the series of conductive fibers.

12. The textile of claim 1, wherein the at least one resistive fiber is woven into the textile.

13. The textile of claim 1, wherein the at least one resistive fiber is sewn or embroidered into the textile.

14. The textile of claim 1, wherein the at least one resistive fiber is adhered to the textile.

15. The textile of claim 1, wherein each contact comprises a discrete electrical connector.

16. The textile of claim 6, wherein the thermoresponsive colorant comprises a first composition of a first color applied to the textile in the region of the resistive fiber, the thermoresponsive colorant within the resistive fiber is a second color, and the first and second colors mix to form a third color when electrical power is supplied.

17. A method for manufacturing a textile, the method comprising:
a. providing a plurality of spaced-apart contacts for receiving electrical power;
b. electrically coupling the contacts to at least one resistive fiber running along a second direction; and
c. providing a thermoresponsive colorant along at least a portion of the at least one resistive fiber, the colorant changing color in response to heat, a voltage across the contacts causing the at least one resistive fiber to produce the heat and thereby change the color of the colorant.

18. The method of claim 17, wherein the thermoresponsive colorant-is responsive within a temperature range of about 31° C. to about 45° C.

19. The method of claim 17, wherein the thermoresponsive colorant is responsive within a temperature of about 31° C. to about 34° C.

20. The method of claim 17, wherein the thermoresponsive colorant is in the form of an ink applied to the textile in the region of the at least one resistive fiber.

21. The method of claim 17, wherein the thermoresponsive colorant is in the form of a dye applied to the textile in the region of the at least one resistive fiber.

22. The method of claim 17, wherein at least a portion of the thermoresponsive colorant is within the at least one resistive fiber.

23. The method of claim 17, wherein the textile is embroidered with the at least one resistive fiber in a shape of interest.

24. The method of claim 17, wherein the contacts and the at least one resistive fiber are coupled so as to minimize the resistance therebetween.

25. The method of claim 24, wherein the resistance is less than about 10 Ω.

26. The method of claim 17, wherein the at least one resistive fiber has a resistance between about 15 to about 100 Ω.

27. The method of claim 17, wherein each contact comprises a series of conductive fibers running along a second direction distinct from the first.

28. The method of claim 27, wherein at least a portion of the thermoresponsive colorant is within at least one of the series of conductive fibers.

29. The method of claim 17, wherein the at least one resistive fiber is woven into the textile.

30. The method of claim 17, wherein the at least one resistive fiber is sewn or embroidered into the textile.

31. The method of claim 17, wherein the at least one resistive fiber is adhered to the textile.

32. The method of claim 17, wherein each contact comprises a discrete electrical connector.

33. The method of claim 27, wherein the series of conductive fibers runs along a weft direction and the at least one resistive fiber runs along a warp direction.

34. The method of claim 22, wherein the thermoresponsive colorant comprises a first composition of a first color applied to the textile in the region of the at least one resistive fiber, the thermoresponsive colorant within the at least one resistive fiber is a second color, and the first and second colors mix to form a third color when electrical power is supplied.

35. The method of claim 23, further comprising separating at least two of the plurality of spaced-apart contacts by cutting the series of conductive fibers.

36. The method of claim 17, further comprising insulating at least two of the plurality of spaced-apart contacts by weaving a non-conductive fabric therebetween.

37. The method of claim 27, further comprising attaching at least one lead comprising at least one conductive fiber to at least one of the series of conductive fibers.

38. A system including a textile with addressable color characteristics, the system comprising:
a. a first set of spaced-apart resistive fibers extending along a first direction;
b. interwoven therewith, a second set of spaced-apart resistive fibers extending along a second direction;
c. a thermoresponsive colorant at least at points of intersection between fibers of the first set and fibers of the second set; and
d. a power source connectable to selected ones of the first set of fibers and the second set of fibers, application of a voltage across intersecting fibers causing the thermoresponsive colorant to change color only in a region where the intersecting fibers cross.

39. The system of claim 38 wherein the thermoresponsive colorant undergoes color change as a function of time and of a voltage through a resistive fiber in contact with the colorant, the color change exhibiting hysteresis, the system further comprising a controller for operating the power source to vary, over time, the fibers to which power is applied in order to activate only selected points of intersection without interference by neighboring points of intersection.
